(19) United States
(12) Patent Application Publication
(10) Pub. No.: US 2012/0030977 A1
(43) Pub. Date: Feb. 9, 2012

(54) ONE-PIECE EAR TAG

(76) Inventor: Ronald K. Knapp, Cody, WY (US)

(21) Appl. No.: 13/204,030

(22) Filed: Aug. 5, 2011

Related U.S. Application Data
(60) Provisional application No. 61/371,290, filed on Aug. 6, 2010.

(51) Int. Cl. A01K 11/00

(52) U.S. Cl. 40/301

(57) ABSTRACT

An ear tag is provided and may include a main body and a stem extending from the main body and having a first bore formed therethrough. A head may be disposed at a distal end of the stem and may include a tip and a plurality of retention features. The tip may be received within the first bore and may overlap the plurality of retention features to transmit a force applied to the tip to the stem and the plurality of retention features.

### CROSS-REFERENCE TO RELATED APPLICATIONS

This application claims the benefit of U.S. Provisional Application No. 61/371,290 filed on Aug. 6, 2010. The entire disclosure of the above application is incorporated herein by reference.

### FIELD

The present disclosure relates to tags and more particularly to ear tags for use with animals.

### BACKGROUND

This section provides background information related to the present disclosure which is not necessarily prior art.

Ear tags are used in a wide variety of applications to identify and differentiate between animals. Ear tags may be inserted into and through an ear of an animal and may include a number or other marking identifying the particular animal.

Conventional ear tags typically include either a one-piece construction or a two-piece construction. A conventional one-piece ear tag is inserted through a cut made in an ear of an animal formed by a blade or other installation tool. Once installed, the one-piece ear tag extends through the ear such that the tag remains in contact with the animal's ear. A conventional two-piece ear tag typically includes a male portion extending through a cut formed in an ear of an animal and a female portion matingly receiving the male portion to lock the two-piece ear tag relative to the animal's ear. The male portion and the female portion cooperate to prevent removal of the ear tag from the animal's ear once installed.

In each of the foregoing ear-tag configurations, a cut must be made through an ear of an animal prior to the ear tag being installed. As such, conventional ear tags require that the ear of the animal be pierced or otherwise cut prior to installation of the one-piece or two-piece tag into the animal's ear. Two-piece tags require an additional step yet in that a male component of the tag must be inserted not only through the animal's ear but into a female component to properly install the tag. As can be appreciated, requiring a piercing step prior to inserting the tag into the animal's ear and subsequently requiring installation of a male component into a female component increases the complexity and the time it takes in which to install an ear tag properly in an animal's ear. Given that the animal is conscious during installation of the tag, increasing the complexity and/or time required to install the ear tag increases the difficulty in properly attaching the tag to the animal's ear.

### SUMMARY

This section provides a general summary of the disclosure, and is not a comprehensive disclosure of its full scope or all of its features.

An ear tag is provided and may include a main body and a stem extending from the main body and having a first bore formed therethrough. A head may be disposed at a distal end of the stem and may include a tip and a plurality of retention features. The tip may be received within the first bore and may overlap the plurality of retention features to transmit a force applied to the tip to the stem and the plurality of retention features.

In another configuration, an ear tag is provided and may include a main body and a stem extending from the main body and having a first bore formed therethrough. A head may be disposed at a distal end of the stem and may include a tip. The tip may be received within the first bore, may include a second bore in fluid communication with the first bore, and may be recessed into the stem within the first bore such that the second bore is substantially flush with the first bore.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a tag installed in an ear of an animal;

FIG. 2 is a perspective view of a tag in accordance with the principles of the present disclosure;

FIG. 3 is a partial side view of the tag of FIG. 2; and

FIG. 4 is a partial cross-sectional view of the ear tag of FIG. 2.

Corresponding reference numerals indicate corresponding parts throughout the several views of the drawings.

### DETAILED DESCRIPTION

Example embodiments will now be described more fully with reference to the accompanying drawings.

With reference to the figures, a tag 10 is provided and may include a main body 12, a stem 14, and a head 16. The stem 14 and head 16 cooperate to attach and retain the tag 10 in a position relative to an ear 18 of an animal 20 such that the main body 12 is visible from at least one side 22, 24 of the ear 18. While the tag 10 will be described and shown with respect to an ear 18 of an animal 20, the tag 10 could alternatively be installed in another location of the animal 20 and is not limited to installation in an ear.

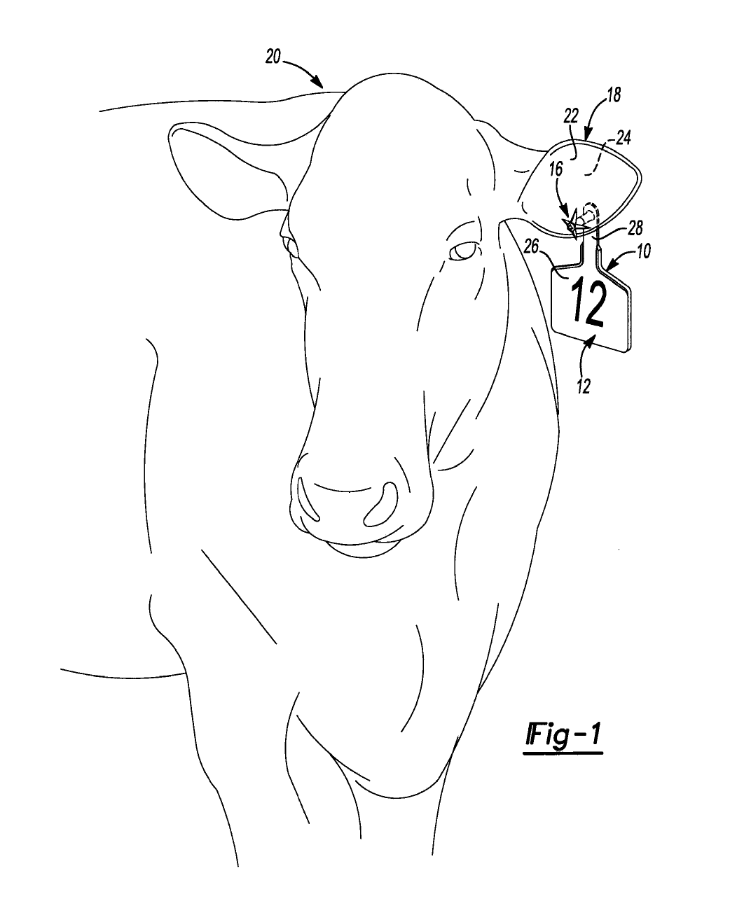

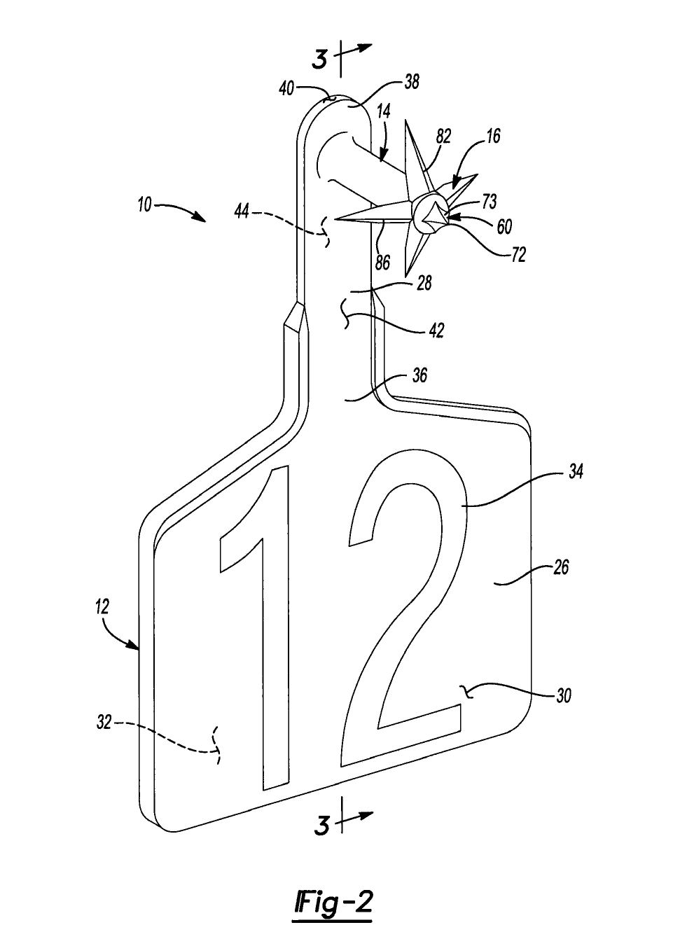

The main body 12 may extend generally from the ear 18 (FIG. 1) and may include a display portion 26 and an arm 28. The display portion 26 may be integrally formed with the arm 28 and may include a first surface 30, a second surface 32 formed on an opposite side of the display portion 26 than the first surface 30, and a number or other marking 34. The number or marking 34 may be formed on either the first surface 30 or the second surface 32 or, alternatively, may be formed on each of the first surface 30 and the second surface 32 such that the number or marking 34 is visible from each side 22, 24 of the ear 18.

The arm 28 may extend generally from the display portion 26 and may include a first end 36 attached to the display portion 26, a second end 38 having an arcuate surface 40, and first and second surfaces 42, 44 extending generally between the first end 36 and the second end 38. The first surface 42 may be positioned on an opposite side of the arm 28 than the second surface 44 and may be positioned on the same side of the main body 12 as the stem 14 and head 16. The second surface 44 may be positioned on an opposite side of the arm 28 than the first surface 42 such that the second surface 44 is formed on an opposite side of the main body 12 than the stem 14 and head 16.

The stem 14 may extend from the first surface 42 of the arm 28 and may include a cylindrical body 46 and a bore 48. The cylindrical body 46 may extend generally between the first surface 42 of the arm 28 and the head 16 and may be integrally formed with the arm 28 and at least a portion of the head 16. The bore 48 may be formed through the cylindrical body 46 and may include an outer surface 50, an inner surface 52, and an opening 54. While the body 46 is described as being cylindrical, the body 46 could alternatively include any geometrical shape. For example, the body 46 may include a shape having at least one angle and/or at least one planar surface to prevent or otherwise restrict relative rotation between the stem 14 and the ear 18.

The opening 54 is in fluid communication with the bore 48 and may extend from the second surface 44 of the arm 28 along a longitudinal axis 56 of the bore 48 (FIG. 4). The opening 54 may include a taper 58 such that a diameter of the opening 54 proximate to the second surface 44 of the arm 28 is greater than the diameter of the bore 48 disposed generally between the first surface 42 of the arm 28 and the head 16.

The head 16 may be disposed at a distal end of the stem 14 and may include a tip 60, at least one retention feature 62, and a bore 64. The retention features 62 may be integrally formed with the stem 14 such that the retention features 62 and stem 14 are integrally formed with the main body 12. In one configuration, the main body 12, stem 14, and retention features 62 include a uniform construction and are formed via an injection-molding process, for example.

The tip 60 may include a first end 66, a second end 68, and a bore 70. The first end 66 may include a cutting feature 72 that punctures the ear 18 when the head 16 initially engages the ear 18. The second end 68 may be disposed at an opposite end of the tip 60 than the first end 66 and may include an opening 74 in fluid communication with the bore 70. The first end 66 may be recessed into a portion of the stem 14 (FIG. 4) such that an inner surface 76 of the bore 70 is substantially flush with the inner surface 52 of the bore 48.

The tip 60 may be molded integrally with the retention features 62. Specifically, when the retention features 62 are molded with the stem 14 and main body 12, the tip 60 may be inserted into the mold such that when the main body 12, stem 14, and retention features 62 are formed, the tip 60 is integrally formed therewith. The tip 60 may be formed from a harder material than the main body 12, stem 14, and retention features 62 such that the tip 60 is relatively rigid. Providing the tip 60 with a rigid construction enhances the ability of the cutting feature 72 to puncture the ear 18 when the tag 10 is installed.

The cutting feature 72 may include a series of sloped surfaces 73 that cooperate with the cutting feature 72 to puncture the ear 18. The sloped surfaces 73 may terminate at an end 75, may engage a portion of each retention feature 62, and may include pointed or sharp leading edges that cooperate with the cutting feature 72 to puncture the ear 18. The ends 75 of the sloped surfaces 73 may overlap a portion of the retention features 62 such that when a force is applied to the cutting feature 72 via the ear 18, the force may be transmitted along the sloped surfaces 73 of the tip 60 and into the retention features 62 at the ends 75. Positioning the ends 75 relative to each retention feature 62, as shown in FIG. 4, allows forces applied to the cutting feature 72 by the ear 18 to be transmitted along the tip 60 and dispersed into the retention features 62.

The bore 70 may extend only partially into the tip 60 and may include a longitudinal axis 78 and a recess 80 having an arcuate surface 81. The longitudinal axis 78 may be aligned with the longitudinal axis 56 such that the bore 48 of the stem 14 is concentric with the bore 70 of the tip 60 when the tip 60 is received within the bore 64 of the head 16. The recess 80 may be disposed at a distal end of the bore 70 and may be positioned along the longitudinal axis 78 such that the recess 80 is aligned with the cutting feature 72 along the longitudinal axis 78. While recess 80 is disclosed as having an arcuate surface 81, the distal end of the bore 70 could include any shape and may take a different form to accommodate a distal end of an installation tool (not shown) received within the bore 70. For example, the distal end of the bore 70 may include a shape that matingly receives a distal end of the installation tool.

The retention features 62 may extend generally between the stem 14 and the tip 60 and may each include a leading edge 82 and a trailing edge 84. The leading edge 82 may include a sloped surface 86 that facilitates insertion of the retention features 62 into the ear 18. The trailing edge 84 may include a clearance 88 that permits the retention features 62 to deflect generally towards the stem 14 when the head 16 is inserted into the ear 18. Permitting the retention features 62 to flex and bend such that the trailing edge 84 moves toward the stem 14 reduces the opening required in the ear 18 to allow the head 16 to pass therethrough. In one configuration, the main body 12, stem 14, and retention features 62 are formed from a flexible material such that the retention features 62 are permitted to flex when a force is applied at the leading edge 82, as the head 16 punctures and moves through an opening formed in the ear 18.

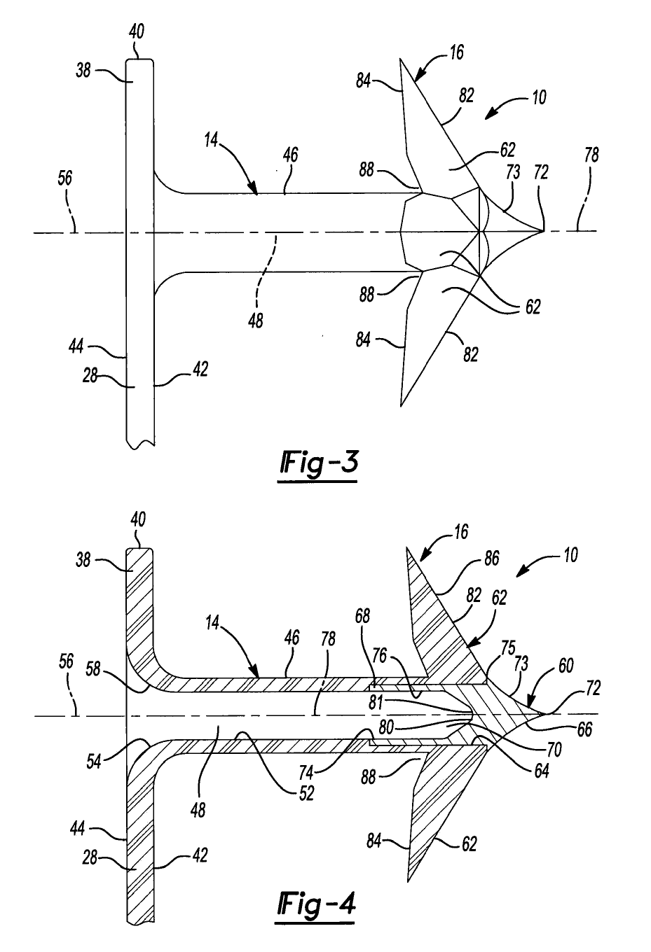

With particular reference to FIGS. 1, 3, and 4, operation of the tag 10 will be described in detail. The tag 10 may be inserted through the ear 18 of the animal 20 by applying a force to the tip 60 such that the cutting feature 72 punctures the ear 18. Specifically, an installation tool (not shown) may be inserted into the bore 48 of the stem 14 at the opening 54 and may engage the recess 80 of the tip 60 to apply a force on the tip 60. The force is applied substantially along the longitudinal axis 56 of the bore 48 and, thus, along the longitudinal axis 78 of the bore 64 of the tip 60 to apply the force directly on the cutting feature 72. The applied force causes the cutting feature 72 to engage one side 24 of the ear 18. The other side 22 of the ear 18 may be supported by a portion of the installation tool such as a pair of upwardly extending arms (neither shown) that both support the side 22 of the ear 18 and permit the head 16 to pass through the ear 18 and generally between the upwardly extending arms.

As described, the force applied along the longitudinal axes 56, 78 is applied in the direction of insertion. As such, the force applied to the recess 80 is directly transmitted to the cutting feature 72 to allow the cutting feature 72 to puncture the ear 18 and create an opening through which the head 16 may pass. Continuing to apply the force on the tip 60 once the cutting feature 72 punctures the ear 18 causes the retention features 62 to deflect and move toward the stem 14. Specifically, the trailing edges 84 of each retention feature 62 move toward the stem 14 and into the clearance 88 to reduce the overall size of the head 16 as the head 16 passes through the ear 18. Once the head 16 passes through the ear 18, the retention features 62 automatically return to an extended position due to the flexible material of the retention features 62 to allow the trailing edge 84 to engage side 22 of the ear 18 and prevent removal of the tag 10 from the ear 18.

Once installed, the trailing edge 84 of each retention feature 62 generally opposes the side 22 of the ear 18 while the first surface 42 of the arm 28 opposes the opposite side 24 of the ear 18. Once installed, the ear 18 is essentially disposed between the first surface 42 of the arm 28 and the trailing edge 84 of each retention feature 62.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An ear tag comprising:
a main body;
a stem extending from said main body and including a first bore formed therethrough; and
a head disposed at a distal end of said stem and including a tip and a plurality of retention features, said tip received within said first bore and overlapping said plurality of retention features to transmit a force applied to said tip to said stem and said plurality of retention features.

2. The ear tag of claim 1, wherein said tip includes a second bore having a longitudinal axis that is coaxial with a longitudinal axis of said stem.

3. The ear tag of claim 2, wherein said second bore is in fluid communication with said first bore.

4. The ear tag of claim 2, wherein said stem includes a first end having an opening operable to receive an installation tool and a second end receiving said tip, said first end in fluid communication with said second bore via said first bore.

5. The ear tag of claim 4, wherein said opening includes a larger diameter than a diameter of said first bore.

6. The ear tag of claim 1, wherein said tip includes a first end forming a cutting feature and a second end received within said first bore.

7. The ear tag of claim 6, wherein said second end engages said stem within said first bore.

8. The ear tag of claim 6, wherein said second end is recessed into said stem such that an inner diameter of said first bore is substantially flush with an inner diameter of said tip.

9. The ear tag of claim 1, wherein said tip is formed from a different material than said stem.

10. The ear tag of claim 1, wherein said main body includes a display portion operable to display a number or other marking.

11. An ear tag comprising:
a main body;
a stem extending from said main body and including a first bore formed therethrough; and
a head disposed at a distal end of said stem and including a tip, said tip received within said first bore, including a second bore in fluid communication with said first bore, and recessed into said stem within said first bore such that said second bore is substantially flush with said first bore.

12. The ear tag of claim 11, further comprising a plurality of retention features operable between a deflected state and a relaxed state, said plurality of retention features being in said deflected state during installation and in said relaxed state prior to and following installation of the ear tag on an ear.

13. The ear tag of claim 12, wherein said plurality of retention features include a clearance between an outer surface of said stem and a trailing edge of said plurality of retention features, said clearance facilitating movement of said plurality of retention features from said relaxed state to said deflected state.

14. The ear tag of claim 12, wherein said tip overlaps said plurality of retention features to transmit a load applied to said tip to said stem and said plurality of retention features.

15. The ear tag of claim 12, wherein said tip includes a plurality of sloped surfaces respectively aligned with said plurality of retention features that cooperate to facilitate insertion of said tip and said plurality of retention features into an ear.

16. The ear tag of claim 11, wherein said stem includes a first end having a first opening operable to receive an installation tool and a second end disposed at an opposite end of said stem from said first end that receives said tip.

17. The ear tag of claim 16, wherein said first end includes a larger diameter than a diameter of said first bore to facilitate insertion of said installation tool into said first bore.

18. The ear tag of claim 11, wherein said tip is formed from a different material than said stem.

19. The ear tag of claim 11, wherein said main body includes a display portion operable to display a number or other marking.

20. The ear tag of claim 11, wherein said second bore is a blind bore terminating at an engagement surface operable to matingly receive an installation tool to allow said installation tool to apply a force directly on said tip.
